(19) United States
(12) Patent Application Publication
(10) Pub. No.: US 2026/0249767 A1
(43) Pub. Date: Aug. 27, 2026

(54) SLIDING PALLET AND GOODS FIXING METHOD FOR REAR BUCKET OF PICKUP TRUCK

(71) Applicant: Tao Jiang, Changzhou (CN)

(72) Inventor: Tao Jiang, Changzhou (CN)

(21) Appl. No.: 19/651,474

(22) Filed: Apr. 17, 2026

(51) Int. Cl. B60P 1/52; B62D 33/037

(52) U.S. Cl. CPC B60P 1/52; B62D 33/037

(57) ABSTRACT

Provided are a pull-and-push sliding pallet and a goods fixing method for a rear bucket of a pickup truck. The sliding pallet includes a pallet body and a sliding mechanism, the pallet body slides on a bottom surface of the truck bucket; a plurality of convex positioning structures are arranged on an upper surface of the pallet body, and at least one positioning clamp block is detachably arranged on the upper surface of the pallet body. A bottom of the positioning clamp block is provided with at least one opening, a shape of the opening matches the convex positioning structures, and the positioning clamp block can be detachably matched with the convex positioning structures through insertion, thereby limiting and fixing the goods on the pallet body. A fixation of the goods on the pallet is achieved through a cooperation of the convex positioning structures and the plug-in positioning clamp block.

### TECHNICAL FIELD

The present disclosure relates to the field of auto parts technologies, and in particular, to a pull-and-push sliding pallet and a goods fixing method for a rear bucket of a pickup truck.

### BACKGROUND

With the widespread application of pickup trucks in logistics transportation, outdoor operations, and other fields, the demand for goods management in the rear bucket of vehicles is increasing. In order to improve the efficiency of goods loading and unloading and the convenience of retrieval, various pull-and-push pallet products have emerged in the market to improve the space utilization and operational convenience of pickup truck rear buckets.

The existing pull-and-push pallet of the pickup truck rear bucket usually includes a pallet body and a sliding mechanism. Firstly, the pallet body is mostly a support plate, lacking a limit structure. After placing goods on the pallet body, the lack of limit structure can easily cause a sliding displacement during vehicle operation. Secondly, the pallet body uses traditional slide rails or guide rail structures to move the pallet back and forth inside the truck bucket, which is complex in structure, high in manufacturing cost, occupies a large space, and is inconvenient to install and maintain. Finally, the pallet body is mostly a fixed size integrated design that cannot be adjusted according to the length of the rear bucket of different pickup truck models, resulting in poor universality and increased production and inventory costs.

The present disclosure proposes a pull-and-push sliding pallet for a rear bucket of a pickup truck, in order to solve technical problems of easy sliding displacement of goods, unsmooth pull-out, and inability to adapt to different vehicle models in pickup truck rear bucket pallet in the prior art mentioned in the background technology.

The technical solution of the present disclosure is implemented as follows.

A pull-and-push sliding pallet for a rear bucket of a pickup truck, including: a pallet body configured to carry goods and being provided on a bottom surface of a truck bucket; a sliding mechanism, which is provided at a bottom of the pallet body and configured for the pallet body to slide the bottom surface of the truck bucket; a plurality of convex positioning structures that are arranged in a regular array on an upper surface of the pallet body; and at least one positioning clamp block, which is detachably provided on the upper surface of the pallet body; a bottom of the positioning clamp block is provided with at least one opening, and a shape of the opening matches the convex positioning structures, so that the positioning clamp block is configured to detachably match with the convex positioning structures through insertion, thereby limiting and fixing the goods placed on the pallet body.

In some embodiments of the present disclosure, the pallet body is composed of a plurality of detachable splicing plates, and the number of splicing plates is configured to adjust according to sizes of truck buckets to adapt to the truck buckets with different lengths.

In some embodiments of the present disclosure, the positioning clamp block is a T-shaped or L-shaped structure and includes a crossbeam and a vertical arm.

In some embodiments of the present disclosure, openings are provided on both the crossbeam and the vertical arm.

In some embodiments of the present disclosure, the protrusion positioning structure includes a plurality of capsule shaped protrusions that are arranged in a staggered manner along transverse and longitudinal directions.

In some embodiments of the present disclosure, the protrusion positioning structure further includes a plurality of cross shaped protrusions, which are arranged at gaps between adjacent capsule shaped protrusions to form an anti-slip support array.

In some embodiments of the present disclosure, a top of the positioning clamp block is provided with a protruding stacking structure adapted to the openings to achieve a vertical stacking installation of a plurality of positioning clamp blocks.

In some embodiments of the present disclosure, the sliding mechanism includes a plurality of rollers, and the plurality of rollers are respectively provided on two sides of the bottom of the pallet body.

In some embodiments of the present disclosure, both the crossbeam and the vertical arm are provided with installation notches, and sizes of the installation notches are larger than external dimensions of the convex positioning structures.

In some embodiments of the present disclosure, a reinforcement partition is provided at a bottom of a joint between adjacent two splicing plates, and the reinforcement partition has a plate-like structure and is fixedly connected to the adjacent splicing plates on two sides.

In some embodiments of the present disclosure, shapes of the openings are a cross-star shape or a capsule shape.

In some embodiments of the present disclosure, the splicing plates are provided with an edge frame with a plurality of fastening holes, and the fastening holes are configured to assemble fasteners to achieve splicing fixation between adjacent splicing plates.

In some embodiments of the present disclosure, a limit mechanism is provided at an edge of the pallet body to limit a movement range of the pallet body inside the truck bucket.

A method for fixing goods in a rear bucket of a pickup truck using a pull-and-push sliding pallet, including: providing a pallet body, where an upper surface of the pallet body is integrally formed with a plurality of convex positioning structures arranged in a regular array, and a bottom of the pallet body is provided with a sliding mechanism; causing the pallet body to slide from an inside of the bucket body to an outside of the bucket body through the sliding mechanism; placing to-be-fixed goods on the pallet body; selecting at least one positioning clamp block, where a bottom of the positioning clamp block is provided with an opening that matches a structure of the convex positioning; inserting the positioning clamp block into a selected position of the convex positioning structures, so that the positioning clamp block forms at least one directional limit constraint on the goods; using the convex positioning structures to provide anti-slip support for bottoms of the goods, and using the positioning clamp block to laterally limit the goods; by using the sliding mechanism to cause the pallet body to slide into the truck bucket, and completing fixation and loading of the goods.

In some embodiments of the present disclosure, the pallet body is composed of a plurality of splicing plates, and the number of splicing plates is adjusted to adapt to truck buckets with different lengths.

In some embodiments of the present disclosure, the positioning clamp block is a T-shaped or L-shaped structure, which forms a multi-directional limit on edges and corners of the goods through a crossbeam and a vertical arm, respectively, to adapt to irregularly shaped goods.

In some embodiments of the present disclosure, the positioning clamp block is inserted into the selected position of the convex positioning structures, a plurality of positioning clamp blocks are arranged around peripheries and corners of the goods to form a surrounding limit structure for the goods.

In some embodiments of the present disclosure, placing of the goods includes pressing one side of the goods against a side wall of the bucket body, and limiting the positioning clamp block on the opposite side, thereby forming a coordinated fixation between the side wall of the bucket body and the positioning clamp block.

In some embodiments of the present disclosure, stacking the plurality of positioning clamp blocks along a vertical direction to increase a limit height of the goods.

In some embodiments of the present disclosure, during unloading of goods, the pallet body is pulled out from the truck bucket to an outside of the truck bucket by a sliding mechanism to retrieve the goods.

By adopting the above technical solution, the beneficial effects of the present disclosure are as follows.

(1) The present disclosure achieves flexible multi-point fixation of goods on the pallet through a combination of convex positioning structures and plug-in positioning clamp blocks. At the same time, the positioning clamp blocks can be inserted at any position in the array of convex positioning structures, which can adapt to the fixing needs of goods of different sizes, effectively prevent sliding displacement of goods during transportation, and improve transportation safety.

(2) The present disclosure adopts rollers to replace the traditional slide rail or guide rail structure, simplifies the pull mechanism, reduces manufacturing costs and space occupation, makes the pulling operation of the pallet smoother and more convenient, and improves the user experience.

(3) The pallet body of the present disclosure adopts a splicing modular structure, which can adapt to pickup truck models of different lengths by adjusting the number of splicing plates, improving the universality of the product, reducing production and inventory costs, and expanding the market applicability.

(4) The present disclosure provides the reinforcement partition at the bottom of the joint, significantly enhancing the structural strength of the joint, preventing the pallet from breaking or deforming when carrying heavy objects, extending its service life, and improving safety.

### BRIEF DESCRIPTION OF DRAWINGS

In order to provide a clearer explanation of the embodiments of the present disclosure or the technical solutions in the prior art, a brief introduction will be given to the accompanying drawings required for the description of the embodiments or the prior art. It is obvious that the accompanying drawings described below are only some embodiments of the present disclosure. For those skilled in the art, other drawings can be obtained based on these drawings without creative work.

FIG. 1 is a three-dimensional schematic diagram of the present disclosure.

FIG. 2 is a schematic bottom view of the present disclosure.

FIG. 3 is an enlarged schematic structural diagram of point A in FIG. 1 of the present disclosure.

FIG. 4 is a schematic bottom view of a positioning clamp block of the present disclosure.

FIG. 5 is an enlarged schematic structural diagram of point B in FIG. 2 of the present disclosure.

FIG. 6 is a schematic diagram of the present disclosure when goods being limited by the positioning clamp block.

FIG. 7 is a schematic diagram of goods being limited by the positioning clamp block from another perspective of the present disclosure.

FIG. 8 is a schematic diagram of a pallet body sliding out of a truck bucket of the present disclosure.

FIG. 9 is a schematic diagram of the pallet body being fully inserted into the truck bucket and sliding out of the present disclosure.

FIG. 10 is a schematic diagram of a front view of the present disclosure.

FIG. 11 is a schematic top view of the present disclosure.

FIG. 12 is a schematic front view of another embodiment of the present disclosure.

FIG. 13 is a schematic top view of another embodiment of the present disclosure.

FIG. 14 is an installation schematic diagram of a reinforcement partition being installed on adjacent two splicing plates of the present disclosure.

FIG. 15 is a schematic diagram of a stacked positioning clamp block limiting the goods of the present disclosure.

Numeral reference: 1- pallet body; 101- splicing plate; 1011- edge frame; 10111- fastening hole; 2- sliding mechanism; 3- convex positioning structure; 301- cross shaped protrusion; 302- capsule shaped protrusion; 4- positioning clamp block; 401- opening; 402- crossbeam; 403- vertical arm; 404- protruding stacking structure; 405- installation notch; 5- limit mechanism; 501- threaded rod; 502- limit block; 503- toggle block; 504- limit plate; 505- guide rod; 506- positioning pin; 6- reinforcement partition.

### DESCRIPTION OF EMBODIMENTS

Below, the technical solutions in the embodiments of the present disclosure will be clearly and completely described in combination with the accompanying drawings. Obviously, the described embodiments are only a part of the embodiments of the present disclosure, not all of them. Based on the embodiments of the present disclosure, all other embodiments obtained by those skilled in the art without creative work are within the protection scope of the present disclosure.

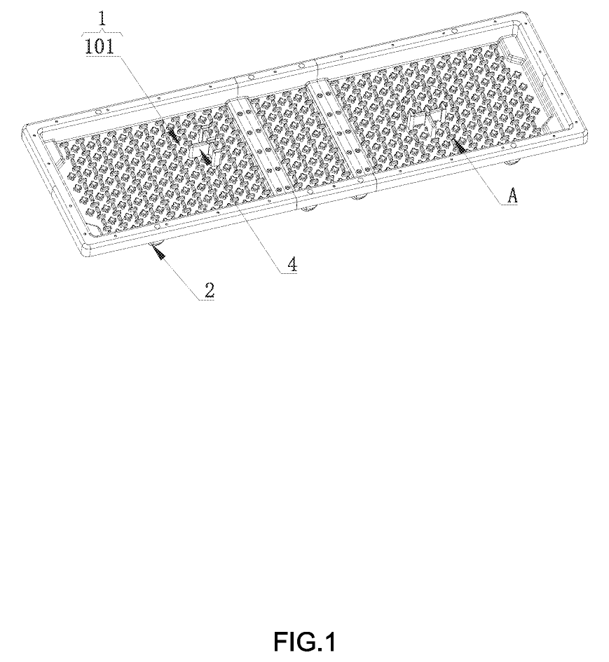

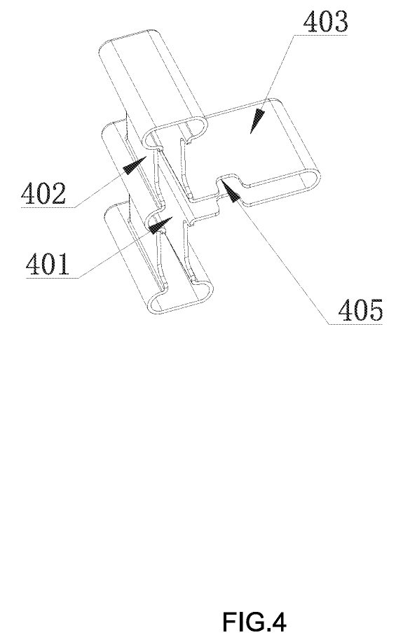

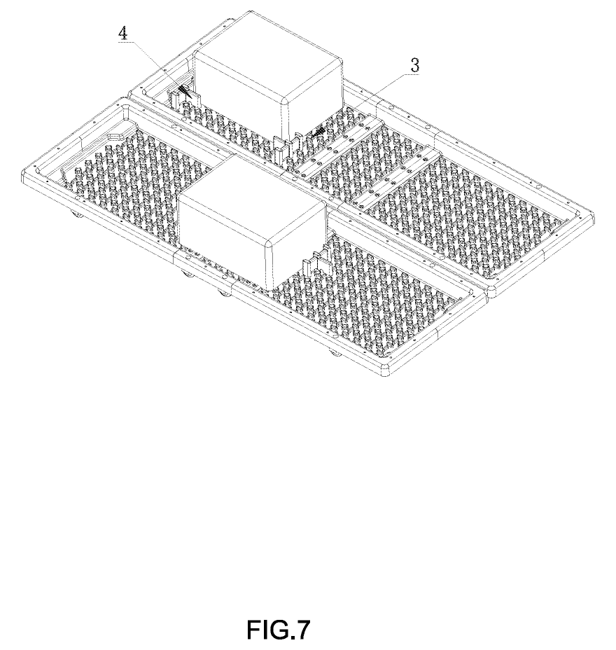

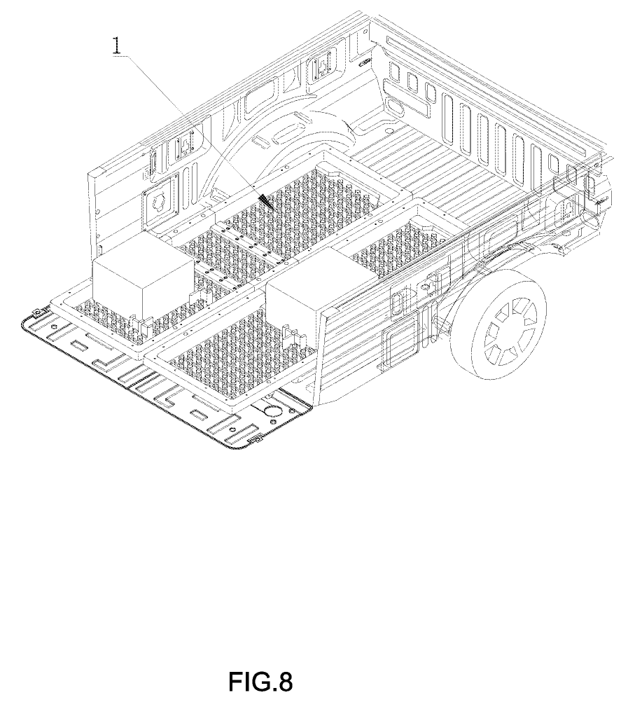

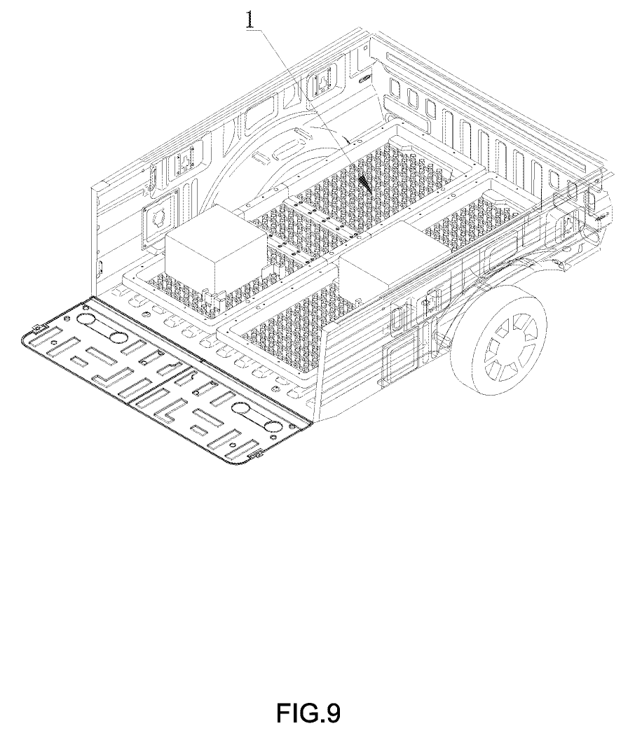

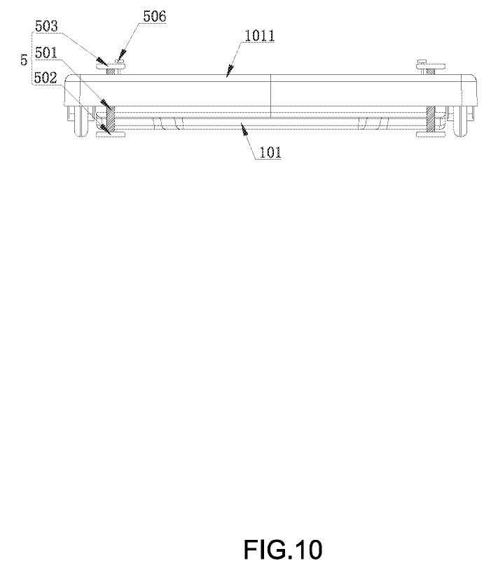

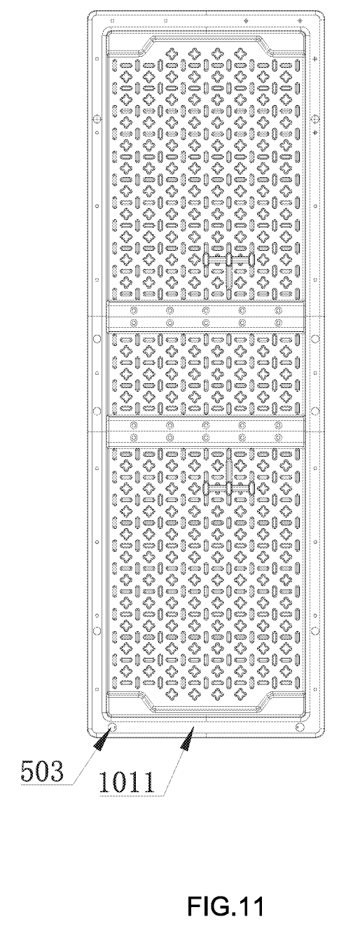

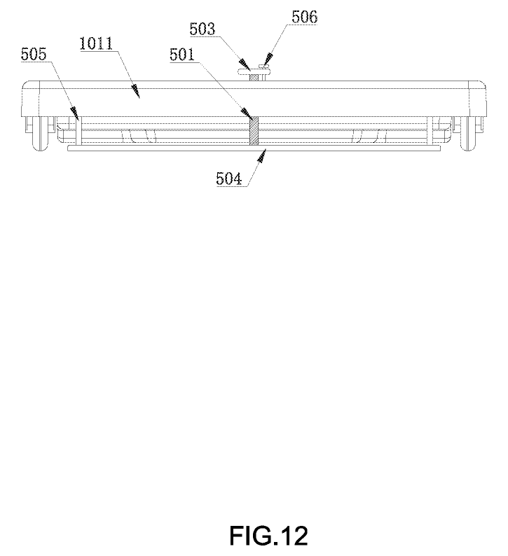

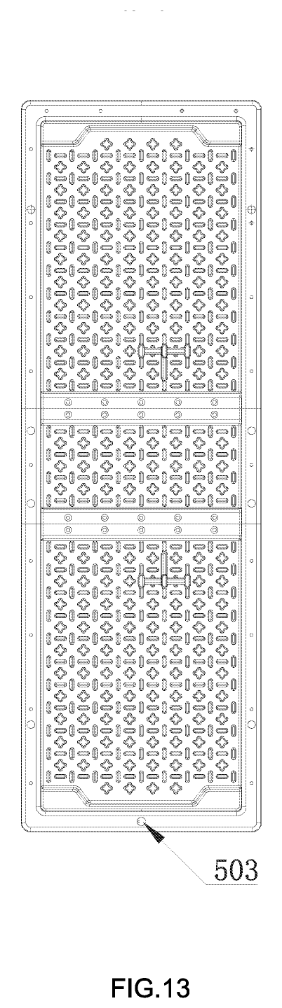

Referring to FIGS. 1-15, a pull-and-push sliding pallet for a rear bucket of a pickup truck includes a pallet body 1, a sliding mechanism 2, convex positioning structures 3, and positioning clamp blocks 4. The sliding mechanism 2 is configured to cause the pallet body 1 to slide relative to a bottom surface of the truck bucket, and the convex positioning structures 3 are provided on an upper surface of the pallet body 1. The convex positioning structures 3 are arranged in a regular array, and the positioning clamp blocks 4 are detachably provided on the upper surface of the pallet body 1. A bottom of the positioning clamp blocks 4 is provided with openings 401 that matches shapes of the convex positioning structures 3. The positioning clamp blocks 4 are inserted and matched with the convex positioning structures 3 through the openings 401 to achieve a positioning fixation.

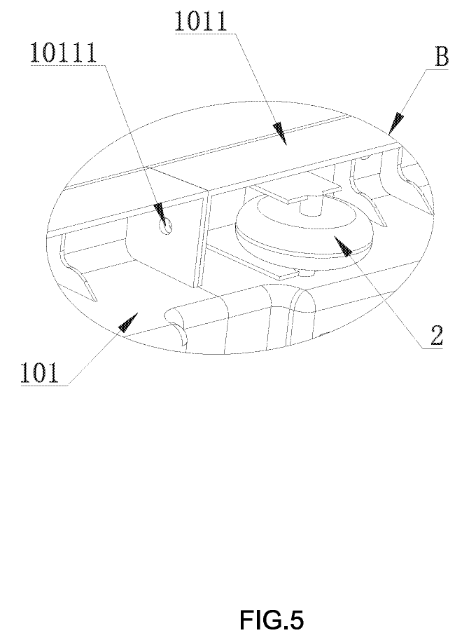

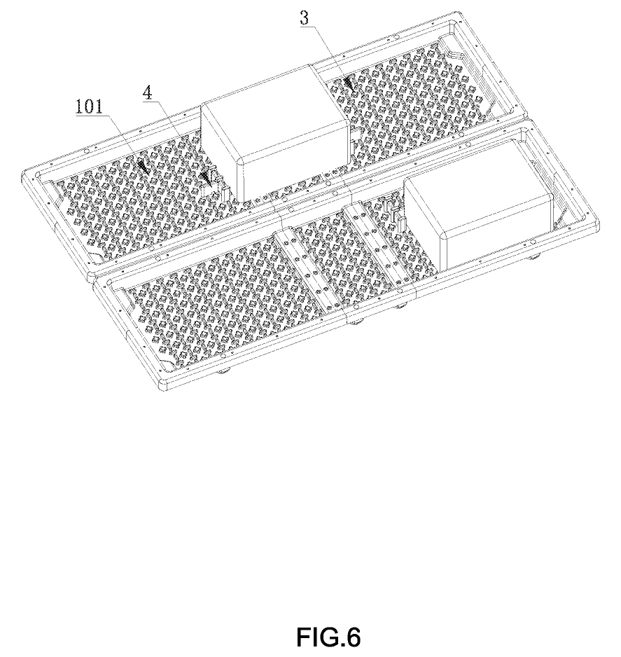

In an implementation mode, as shown in FIGS. 5 and 6, goods are placed on the convex positioning structures 3 on the upper surface of the pallet body 1. Under the action of the convex positioning structures 3, it can provide support for the goods and friction for the goods. Then, the positioning clamp blocks 4 are inserted and fixed on the convex positioning structures 3 through the openings 401, and the positioning clamp blocks 4 are arranged around a periphery of the goods. The combination of a plurality of positioning clamp blocks 4 can form a fence structure, which limits a movement of the goods from a plurality of directions and ensures a stable fixation of the goods on the pallet body 1. At this time, under the action of the positioning clamp blocks 4, it can further limit the movement of the goods on the pallet body 1, so that the goods are firmly fixed.

In an implementation mode, the convex positioning structures 3 include cross shaped protrusions 301 and capsule shaped protrusions 302; and the cross shaped protrusions 301 and the capsule shaped protrusions 302 are arranged in a staggered manner.

Specifically, the capsule shaped protrusions 302 are arranged in a staggered manner along horizontal and vertical directions. The cross shaped protrusions 301 are arranged at gaps between adjacent capsule shaped protrusions 302. The cross shaped protrusions 301 and capsule shaped protrusions 302 are arranged in a regular array on the upper surface of the pallet body 1, thereby forming a high-density protrusion array. This array layout provides a plurality of insertion anchor points for the positioning clamp blocks 4, allowing the positioning clamp blocks 4 to be inserted and fixed at any position on the upper surface of the pallet body 1.

The cross shaped protrusions 301 have four rounded corners, and rounded corner design ensures a good fit with the openings 401 and avoiding stress concentration caused by sharp corners, improving the durability of the convex positioning structures 3.

In an implementation mode, the positioning clamp blocks 4 have a T-shaped structure, and the positioning clamp blocks include a crossbeam 402 and a vertical arm 403. The vertical arm 403 extends vertically downward from a middle of the crossbeam 402, and is fixedly connected to the crossbeam 402 to form a T-shaped overall structure. The crossbeam 402 of the T-shaped structure provides a larger contact area for the goods, enhancing the limiting effect on the goods, and the vertical arm 403 provides sufficient structural strength.

Both the crossbeam 402 and the vertical arm 403 adopt a hollow wall panel structure to form the openings 401, and a shape of the openings 401 includes a cross star shape and a capsule shape, which enables the crossbeam 402 and the vertical arm 403 to be disassembled and assembled on the cross shaped protrusions 301 and the capsule shaped protrusions 302.

In an implementation mode, the openings 401 of the positioning clamp blocks 4 are aligned with the cross shaped protrusions 301 or capsule shaped protrusions 302 on the upper surface of the pallet body 1, the positioning clamp blocks 4 are pressed down to cause the openings 401 to be sleeve onto the convex positioning structures 3, and the positioning clamp blocks 4 are fixed on the upper surface of the pallet body 1 through the shape fit between the openings 401 and the convex positioning structures 3. Due to the regular array arrangement of the convex positioning structures 3, the positioning clamp blocks 4 can be inserted at any protruding position on the upper surface of the pallet body 1, thereby achieving flexible adjustment of the positioning position.

Due to the hollow wall panel structure used inside the positioning clamp blocks 4, the weight is reduced and ensuring the strength of the positioning clamp blocks 4, achieving lightweighting.

Two ends of the crossbeam 402 are in the shape of rounded rectangular columns. The rounded rectangular column design not only increases a contact area with the goods but also avoids damage to the surface of the goods caused by sharp corners and improves the structural strength of the positioning clamp blocks 4.

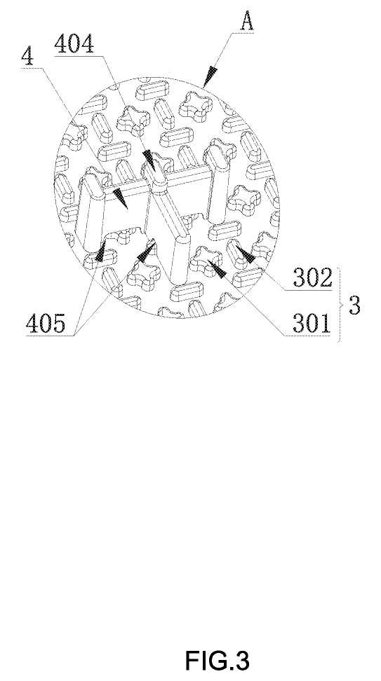

In an implementation mode, as shown in FIG. 3, both the crossbeam 402 and the vertical arm 403 are provided with installation notches 405, and sizes of the installation notches 405 are larger than external dimensions of the convex positioning structures 3. After the crossbeam 402 and the vertical arm 403 are inserted into the cross shaped protrusions 301 and the capsule shaped protrusions 302, they can accommodate similar cross shaped protrusions 301 and capsule shaped protrusions 302 under the action of the installation notches 405, so that the bottom of the positioning clamp blocks 4 contacts the upper surface of the pallet body 1, thus maintaining the stability of the positioning clamp blocks 4.

In an implementation mode, the positioning clamp blocks 4 have an L-shaped structure, and the positioning clamp blocks 4 use a hollow wall panel structure to form the openings 401. Shapes of the openings 401 include a cross star shape and a capsule shape, which enables the crossbeam 402 and the vertical arm 403 to be disassembled and assembled on the cross shaped protrusions 301 and the capsule shaped protrusions 302.

The L-shaped structure is particularly suitable for fixing the corner position of goods, and can simultaneously fix two sides of the corner position of goods. Therefore, the L-shaped structure can provide stronger support at of goods at a corner, effectively preventing the overturning of goods.

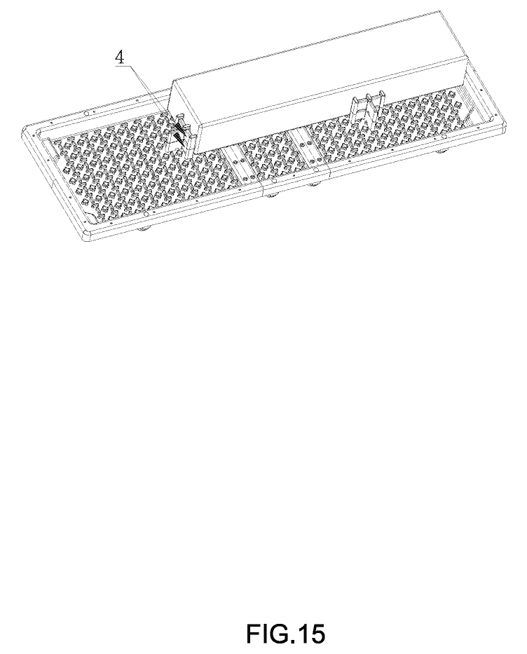

In an implementation mode, tops of the positioning clamp blocks 4 are provided with a protruding stacking structure 404 that is compatible with the openings 401, allowing the plurality of positioning clamp blocks 4 to be stacked and installed vertically (as shown in FIG. 15, which is a schematic diagram of two positioning clamp blocks 4 stacked). When facing goods of different heights, especially those with higher heights, a height of a single positioning clamp block 4 is not enough, resulting in poor support and positioning effects. At this time, the protruding stacking structure 404 is configured to stack the positioning clamp blocks 4 together, thus increasing a total support height. This can make the goods more securely limited, and the number of the positioning clamp blocks 4 stacked depends on the height of the goods.

In an implementation mode, the sliding mechanism 2 includes rollers, and the rollers are arranged at a bottom of the pallet body 1. Under the action of the rollers, the pallet body 1 can move relative to the truck bucket, facilitating the entry and exit of the pallet body 1 into and out of the truck bucket, thereby facilitating the entry and exit of goods into and out of the truck bucket.

There are a plurality of rollers, and the rollers are provided on two sides of the bottom of the pallet body 1, and the plurality of rollers are divided into two groups that are symmetrically distributed along a long side direction of the pallet body 1.

In an implementation mode, the rollers are fixedly connected to a bottom surface of the pallet body 1 through a bearing seat or a bracket. A wheel body of the rollers extends downward, so that outer peripheral surfaces of the rollers contact the bottom surface of the truck bucket. The plurality of rollers are arranged in pairs along the long side direction of the pallet body 1, and several pairs of rollers are provided on two sides of the pallet body 1 to form a balanced support layout. The rollers form rolling contact with the bottom surface of the truck bucket. When pushing and pulling force is applied to the pallet body 1, the rollers roll on the bottom surface of the truck bucket, the pallet body 1 is driven to slide in the front and rear directions relative to the bottom surface of the truck bucket, thereby achieving the pulling function of the pallet body 1.

The use of rollers instead of traditional slide or rail structures simplifies the pulling mechanism, reduces manufacturing costs and space occupation, and makes the pulling operation of the pallet body 1 smoother and more convenient.

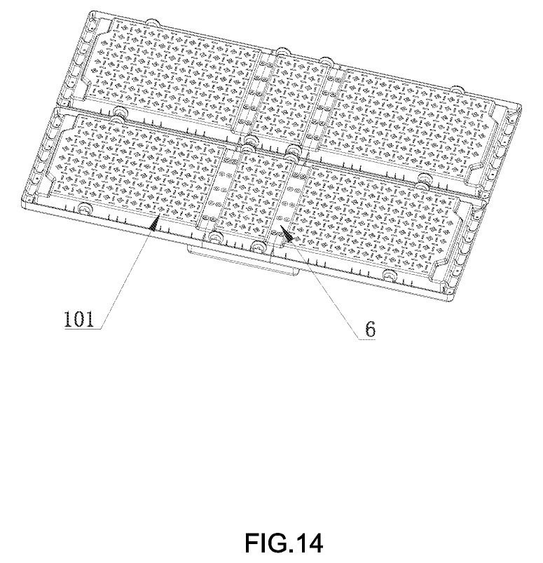

In an implementation mode, the pallet body 1 is composed of at least two splicing plates 101, and a reinforcement partition 6 is provided at a bottom of a splice position between adjacent splicing plates 101 (as shown in FIG. 14). The reinforcement partition 6 has a plate-like structure and is fixedly connected to a bottom of adjacent splicing plates 101.

In an implementation mode, a length direction of the reinforcement partition 6 is perpendicular to a splicing seam. The reinforcement partition 6 is fixedly connected to the bottom of adjacent two splicing plates 101 and spans on two sides of the splicing seam. The reinforcement partition 6 is fixedly connected to a bottom surface of adjacent two splicing plates 101 through bolts, welding, or adhesive bonding, firmly connecting the adjacent two splicing plates 101 together, significantly enhancing the structural strength of the joint and preventing the pallet body 1 from breaking or deforming at the joint when carrying heavy objects.

When facing different truck models, the number of the splicing plates 101 can be adjusted, which can be assembled into pallet bodies 1 of different lengths to adapt to different truck models.

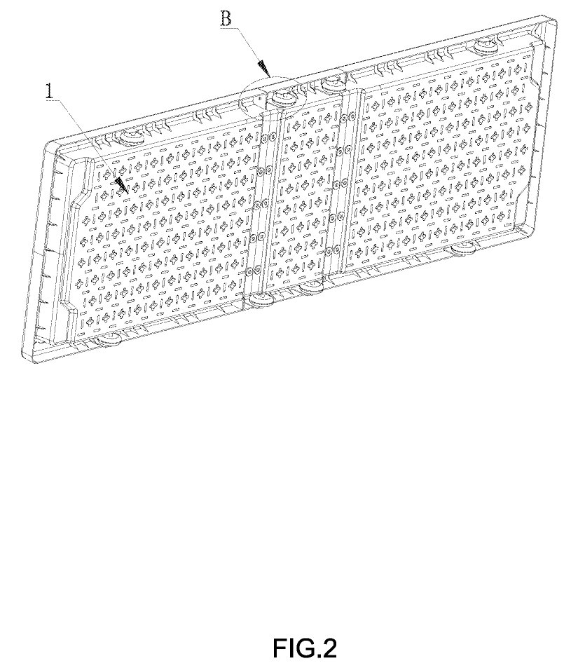

In an implementation mode, as shown in FIGS. 2 and 5, an edge frame 1011 is provided around the splicing plates 101, and a plurality of fastening holes 10111 are provided on the edge frame 1011 for installing fasteners to assemble and fix the two adjacent splicing plates 101.

In an implementation mode, the pallet body 1 is composed of at least two splicing plates 101. Adjacent splicing plates 101 are connected end-to-end in the length direction of the pallet body 1. The fastening holes 10111 provided on the edge frames 1011 of adjacent splicing plates 101 correspond and are connected and are fixed by fasteners. The adjacent splicing plates 101 are joined together by a fixed connection to form a complete pallet body 1.

In an implementation mode, fasteners include but are not limited to bolts.

In an implementation mode, the plurality of rollers are provided on two sides of the edge frame 1011, and the plurality of rollers are divided into two groups that are symmetrically distributed along the long side direction of the edge frame 1011.

In an implementation mode, the rollers are fixedly connected to an interior of the edge frame 1011 through a bearing seat or bracket (as shown in FIG. 5), and the wheel body of the rollers extends downward, so that outer peripheral surfaces of the rollers contact the bottom surface of the bucket, and there is a gap between the splicing plates 101 and the bottom surface of the bucket that does not contact. The plurality of rollers are arranged in pairs along the long side direction of the edge frame 1011.

The pallet body 1 is further provided with a limit mechanism 5 that limits a movement of the pallet body 1 in the truck bucket. Under the action of the limit mechanism 5, the pallet body 1 can be prevented from sliding, so that the pallet body 1 and the goods on it can be stably placed in the truck bucket.

In an implementation mode, the limit mechanism 5 is provided on the edge frame 1011 of the splicing plates 101 close to a tailgate of the pallet body 1, and there are two limit mechanisms 5. The two limit mechanisms 5 are symmetrically provided on a short side of the edge frame 1011. The limit mechanisms 5 include a threaded rod 501 provided on the edge frame 1011, a limit block 502 fixedly provided at a bottom of the threaded rod 501, and a toggle block 503 fixedly provided on a top of the threaded rod 501.

When placing goods, the tailgate of the truck bucket is opened, the pallet body 1 is pulled and it is slid out of the truck bucket, and the goods are placed on the surface of the convex positioning structures 3 of the pallet body 1. The convex positioning structures 3 can provide friction for the goods, initially limiting the goods. Then the positioning clamp blocks 4 are , inserted into the convex positioning structures 3 through the openings 401 to fix it. When the goods are placed by the positioning clamp blocks 4, the positioning clamp blocks 4 can further limit the movement of the goods on the pallet body 1 under the action of the positioning clamp blocks 4, so that the goods are firmly fixed, and then the pallet body 1 is pushed to enter the truck bucket.

After the pallet body 1 is fully inserted into the interior of the truck bucket, due to a threaded installation of the threaded rod 501 and the edge frame 1011, the user holds the toggle block 503 and rotates the threaded rod 501 clockwise. During a rotation process, the threaded rod 501 can drive the limit block 502 to move downward until a bottom of the limit block 502 can contact the bottom surface of the truck bucket. At this time, under the action of the limit block 502, it can prevent the rollers from sliding, and then the tailgate is closed.

In an implementation mode, in order to prevent the threaded rod 501 from rotating due to vibration during vehicle operation, positioning holes are provided on the short sides of the toggle block 503 and the edge frame 1011. When the limit block 502 contacts with a bottom surface of the bucket, the positioning hole provided by the toggle block 503 corresponds to the positioning hole provided on the short side of the edge frame 1011. The positioning pin 506 is inserted from top to bottom into the positioning holes provided by the toggle block 503 and the edge frame 1011, which can prevent the toggle block 503 from rotating and effectively prevent the threaded rod 501 from rotating due to vibration, so that the limit block 502 can contact with the bottom surface of the bucket.

In an implementation mode, a limit mechanism 5 is provided, which is provided on the short side of the edge frame 1011. The limit mechanism 5 includes a threaded rod 501 provided on the edge frame 1011, a limit plate 504 rotatably provided on a bottom of the threaded rod 501, a toggle block 503 fixedly provided on a top of the threaded rod 501, and a guide rod 505 fixedly provided on the edge frame 1011. The limit plate 504 is provided with a guide hole that matches the guide rod 505, and the limit plate 504 is slidably sleeved onto the guide rod 505 through the guide hole. A length of the guide rod 505 has a gap with a diameter of the bottom surface of the bucket body, and the length of the guide rod 505 is greater than a maximum downward displacement of the limit plate 504. In this way, the limit plate 504 is prevented from detaching from the guide rod 505.

Due to the threaded installation of the threaded rod 501 and the edge frame 1011, the user holds the toggle block 503 and rotates the threaded rod 501 clockwise. During the rotation process, the threaded rod 501 can drive the limit plate 504 to move downward until the bottom of the limit plate 504 can contact the bottom surface of the bucket body. At this time, under the action of the limit plate 504, the rollers can be prevented from sliding, and then the tailgate can be closed. In this embodiment, only the toggle block 503 needs to be moved once, rendering the operation more convenient.

In an implementation mode, the positioning holes provided on the short sides of the toggle block 503 and the edge frame 1011 have threads, and the positioning pin 506 has also threads. The positioning pin 506 is screwed into the positioning holes provided on the toggle block 503 and the edge frame 1011, and with the cooperation of the threads, the positioning pin 506 can be fixed, thereby limiting the toggle block 503 and preventing the toggle block 503 and the threaded rod 501 to rotate.

The present disclosure further provides a method for fixing the goods in a rear bucket of a pickup truck using a sliding pallet, including: providing a pallet body 1, an upper surface of the pallet body 1 is integrally formed with a plurality of convex positioning structures 3 arranged in a regular array, and a bottom of the pallet body 1 is provided with a sliding mechanism 2; causing the pallet body 1 to slide from an inside of the bucket body to an outside of the bucket body through the sliding mechanism 2; placing to-be-fixed goods on the pallet body 1; selecting at least one positioning clamp block 4, openings 401 are provided at a bottom of the positioning clamp block 4 that matches convex positioning structures 3; inserting the positioning clamp block 4 into a selected position of the convex positioning structures 3, so that the positioning clamp block 4 forms at least one directional limit constraint on the goods; using the convex positioning structures 3 to provide anti-slip support for the bottom of the goods, and using the positioning clamp block 4 to laterally limit the goods; by sliding mechanism 2, the pallet body 1 being slid into the truck bucket to complete a fixation and loading of the goods.

The positioning clamp block 4 is a T-shaped or L-shaped structure, which forms multi-directional limits on edges and corners of the goods through its horizontal and vertical parts, respectively, to adapt to irregularly shaped goods.

The positioning clamp block 4 is inserted into the selected position of the convex positioning structures 3, the plurality of positioning clamp blocks 4 are arranged around peripheries and corners of the goods to form a surrounding limiting structure for the goods.

Placing of the goods includes pressing one side of the goods against a side wall of the bucket body, and limiting the positioning clamp block 4 on the opposite side, thereby forming a coordinated fixation between the side wall of the bucket body and the positioning clamp block.

Stacking the plurality of positioning clamp blocks 4 along a vertical direction to increase a limit height of the goods.

The method further includes during unloading of goods, the pallet body 1 is pulled out from the truck bucket to an outside of the truck bucket by a sliding mechanism 2 to retrieve the goods.

The above description is only a preferred embodiment of the present disclosure and is not intended to limit the present disclosure. Any modifications, equivalent substitutions, improvements, etc. made within the spirit and principles of the present disclosure should be included in the protection scope of the present disclosure.

What is claimed is:

1. A pull-and-push sliding pallet for a rear bucket of a pickup truck, comprising:
a pallet body configured to carry goods and being provided on a bottom surface of a truck bucket;
a sliding mechanism, which is provided at a bottom of the pallet body and configured for the pallet body to slide the bottom surface of the truck bucket;
a plurality of convex positioning structures that are arranged in a regular array on an upper surface of the pallet body; and
at least one positioning clamp block, which is detachably provided on the upper surface of the pallet body;
a bottom of the positioning clamp block is provided with at least one opening, and a shape of the opening matches the convex positioning structures, so that the positioning clamp block is configured to detachably match with the convex positioning structures through insertion, thereby limiting and fixing the goods placed on the pallet body.

2. The pull-and-push sliding pallet for a rear bucket of a pickup truck according to claim 1, wherein the pallet body is composed of a plurality of detachable splicing plates, and the number of splicing plates is configured to adjust according to sizes of truck buckets to adapt to the truck buckets with different lengths.

3. The pull-and-push sliding pallet for a rear bucket of a pickup truck according to claim 1, wherein the positioning clamp block is a T-shaped or L-shaped structure and comprises a crossbeam and a vertical arm.

4. The pull-and-push sliding pallet for a rear bucket of a pickup truck according to claim 3, wherein openings are provided on both the crossbeam and the vertical arm.

5. The pull-and-push sliding pallet for a rear bucket of a pickup truck according to claim 1, wherein the protrusion positioning structure comprises a plurality of capsule shaped protrusions that are arranged in a staggered manner along transverse and longitudinal directions.

6. The pull-and-push sliding pallet for a rear bucket of a pickup truck according to claim 5, wherein the protrusion positioning structure further comprises a plurality of cross shaped protrusions, which are arranged at gaps between adjacent capsule shaped protrusions to form an anti-slip support array.

7. The pull-and-push sliding pallet for a rear bucket of a pickup truck according to claim 1, wherein a top of the positioning clamp block is provided with a protruding stacking structure adapted to the openings to achieve a vertical stacking installation of a plurality of positioning clamp blocks.

8. The pull-and-push sliding pallet for a rear bucket of a pickup truck according to claim 1, wherein the sliding mechanism comprises a plurality of rollers, and the plurality of rollers are respectively provided on two sides of the bottom of the pallet body.

9. The pull-and-push sliding pallet for a rear bucket of a pickup truck according to claim 3, wherein both the crossbeam and the vertical arm are provided with installation notches, and sizes of the installation notches are larger than external dimensions of the convex positioning structures.

10. The pull-and-push sliding pallet for a rear bucket of a pickup truck according to claim 2, wherein a reinforcement partition is provided at a bottom of a joint between adjacent two splicing plates, and the reinforcement partition has a plate-like structure and is fixedly connected to the adjacent splicing plates on two sides.

11. The pull-and-push sliding pallet for a rear bucket of a pickup truck according to claim 1, wherein shapes of the openings are a cross-star shape or a capsule shape.

12. The pull-and-push sliding pallet for a rear bucket of a pickup truck according to claim 1, wherein the splicing plates are provided with an edge frame with a plurality of fastening holes, and the fastening holes are configured to assemble fasteners to achieve splicing fixation between adjacent splicing plates.

13. The pull-and-push sliding pallet for a rear bucket of a pickup truck according to claim 1, wherein a limit mechanism is provided at an edge of the pallet body to limit a movement range of the pallet body inside the truck bucket.

14. A method for fixing goods in a rear bucket of a pickup truck using a pull-and-push sliding pallet, comprising:
providing a pallet body, wherein an upper surface of the pallet body is integrally formed with a plurality of convex positioning structures arranged in a regular array, and a bottom of the pallet body is provided with a sliding mechanism;
causing the pallet body to slide from an inside of the bucket body to an outside of the bucket body through the sliding mechanism;
placing to-be-fixed goods on the pallet body;
selecting at least one positioning clamp block, wherein a bottom of the positioning clamp block is provided with an opening that matches a structure of the convex positioning (3);
inserting the positioning clamp block into a selected position of the convex positioning structures, so that the positioning clamp block forms at least one directional limit constraint on the goods;
using the convex positioning structures to provide anti-slip support for bottoms of the goods, and using the positioning clamp block to laterally limit the goods;
by using the sliding mechanism to cause the pallet body to slide into the truck bucket, and completing fixation and loading of the goods.

15. The method according to claim 14, wherein the pallet body is composed of a plurality of splicing plates, and the number of splicing plates is adjusted to adapt to truck buckets with different lengths.

16. The method according to claim 14, wherein the positioning clamp block is a T-shaped or L-shaped structure, which forms a multi-directional limit on edges and corners of the goods through a crossbeam and a vertical arm, respectively, to adapt to irregularly shaped goods.

17. The method according to claim 14, wherein the positioning clamp block is inserted into the selected position of the convex positioning structures, a plurality of positioning clamp blocks are arranged around peripheries and corners of the goods to form a surrounding limit structure for the goods.

18. The method according to claim 14, wherein placing of the goods comprises pressing one side of the goods against a side wall of the bucket body, and limiting the positioning clamp block on the opposite side, thereby forming a coordinated fixation between the side wall of the bucket body and the positioning clamp block.

19. The method according to claim 14, wherein stacking the plurality of positioning clamp blocks along a vertical direction to increase a limit height of the goods.

20. The method according to claim 1, wherein during unloading of goods, the pallet body is pulled out from the truck bucket to an outside of the truck bucket by a sliding mechanism to retrieve the goods.
